(19) United States
(12) Patent Application Publication
(10) Pub. No.: US 2024/0402782 A1
(43) Pub. Date: Dec. 5, 2024

(54) PROCESSING AND STORING BATTERY DATA

(71) Applicant: Gotion, Inc., Freemont, CA (US)

(72) Inventors: Mengzhu Gao, Freemont, CA (US); Xiaojun Li, Freemont, CA (US); Trevor Jones, Freemont, CA (US); Yuan Hu, Freemont, CA (US)

(73) Assignee: Gotion, Inc., Freemont, CA (US)

(21) Appl. No.: 18/328,458

(22) Filed: Jun. 2, 2023

(51) Int. Cl. G06F 1/28

(52) U.S. Cl. CPC G06F 1/28; G06F 16/84; G06F 16/88

(57) ABSTRACT

Methods and apparatuses for processing and storing battery data are provided. One of the disclosed methods includes receiving, from a client device, the battery data via a CAN protocol. The method also includes pushing the battery data into a buffer sequentially, wherein the earliest battery data is popped out from the buffer. The method further includes decoding the popped battery data with a CAN DBC file provided by the client device. The method further includes packing the decoded battery data into a JSON file and transmitting the JSON file to a cloud server.

### TECHNICAL FIELD

This disclosure relates to processing and storing battery data.

### BACKGROUND

Battery management system (BMS) has been widely used in electric vehicles (EV) and energy storage systems (ESS) for monitoring and management purpose. Traditionally, BMS gathers data from batteries in EV or ESS through Controller Area Network (CAN) protocol and processes the data on the microcontroller locally. However, there are many constraints for onboard data processing. Firstly, due to the demand for high accuracy of battery state estimation and prediction such as state of charge (SOC), state of health (SOH) prediction, and thermal runaway detection, higher computing power is required for these advanced data-driven algorithms. Furthermore, the onboard data processing cannot support real-time monitoring of the data, which could not meet the demand from customers to monitor the EV/ESS status and alert.

Cloud computing has been widely used nowadays since it provides services such as cloud servers, storage, and analytics over the Internet, which meet the increasing demand for high computing power, scalability, and flexibility. The concept of the Internet of Things (IoT) has become popular since it enables the endpoint devices such as vehicles, and appliances with an internet connection, which enables the data connection and exchange between the devices and the cloud, therefore conducting cloud computing services.

### SUMMARY

One aspect of the disclosure provides a method for processing battery data. The method includes receiving, from a client device, the battery data via a CAN protocol. The method also includes pushing the battery data into a buffer sequentially, wherein the earliest battery data is popped out from the buffer. The method further includes decoding the popped battery data with a CAN DBC file provided by the client device. The method also includes packing the decoded battery data into a JSON file and transmitting the JSON file to a cloud server.

In some implementations, the client device comprises a battery management system (BMS), the BMS gathers the battery data from batteries in the client device.

In some implementations, transmitting the JSON file to a cloud server comprises transmitting the JSON file to the cloud server via MQTT protocol through data distribution server.

In some implementations, the CAN DBC file is provided by the BMS.

In some implementations, the decoded battery data is associated with a topic based on content of the battery data.

Another aspect of the disclosure provides a data processing device. The data processing device includes one or more processors and a non-transitory computer-readable memory coupled to the one or more processors, the memory storing instructions that, when executed by the one or more processors, cause the one or more processors to perform operations. The operations include receiving, from a client device, the battery data via a CAN protocol. The operations also include pushing the battery data into a buffer sequentially, wherein the earliest battery data is popped out from the buffer. The operations further include decoding the popped battery data with a CAN DBC file provided by the client device. The operations further include packing the decoded battery data into a JSON file and transmitting the JSON file to a cloud.

In some implementations, the client device comprises a battery management system (BMS), the BMS gathers the battery data from batteries in the client device.

In some implementations, transmitting the JSON file to a cloud server comprises transmitting the JSON file to the cloud server via MQTT protocol through data distribution server.

In some implementations, the CAN DBC file is provided by the BMS.

In some implementations, the decoded battery data is associated with a topic based on content of the battery data.

Yet another aspect of the disclosure provides a method for storing battery data in a cloud server. The method includes receiving, from a data processing device, a plurality of JSON files, wherein the JSON files are stored in a raw data folder within the cloud server. The method also includes formatting the JSON files in the raw data folder by using a first function, and saving the formatted JSON files in a processed data folder within the cloud server. The method further includes combining the formatted JSON files in the processed data folder by a second function and saving the combined JSON files in a data catalog within the cloud server.

In some implementations, the first function is a filtering function. Formatting the JSON files in the raw data folder by using a first function comprises filtering the JSON files in the raw data folder by using the filtering function so as to remove invalid data or null data.

In some implementations, the second function is a combining function. Combining the formatted JSON files in the processed data folder by a second function comprises classifying the formatted JSON files and combining the formatted JSON files with the same type into the combined JSON files.

In some implementations, the raw data folder and the processed data folder are in a data lake within the cloud server, the data catalog is separate from the data lake.

Another aspect of the disclosure provides a cloud server. The cloud server includes one or more processors and a non-transitory computer-readable memory coupled to the one or more processors, the memory storing instructions that, when executed by the one or more processors, cause the one or more processors to perform operations. The operations include receiving, from a data processing device, a plurality of JSON files, wherein the JSON files are stored in a raw data folder within the cloud server. The operations also include formatting the JSON files in the raw data folder by using a first function, and saving the formatted JSON files in a processed data folder within the cloud server. The operations further include combining the formatted JSON files in the processed data folder by a second function and saving the combined JSON files in a data catalog within the cloud server.

In some implementations, the first function is a filtering function. Formatting the JSON files in the raw data folder by using a first function comprises filtering the JSON files in the raw data folder by using the filtering function so as to remove invalid data or null data.

In some implementations, the second function is a combining function. Combining the formatted JSON files in the processed data folder by a second function comprises classifying the formatted JSON files and combining the formatted JSON files with the same type into the combined JSON files.

In some implementations, the raw data folder and the processed data folder are in a data lake within the cloud server, the data catalog is separate from the data lake.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a block diagram of a computing system in which a method for processing battery data and a method for storing battery data in a cloud server can be implemented;

FIG. 2 shows a structure of a buffer for data sequencing on the data processing device;

FIG. 3 is a flow diagram of a method for processing battery data, which can be implemented in the data processing device of FIG. 1;

FIG. 4 is a flow diagram of a method for storing battery data in a cloud server, which can be implemented in the cloud server of FIG. 1; and

FIG. 5 shows a of the battery data schema that is stored in the data catalog. Like reference symbols in the various drawings indicate like elements.

### DETAILED DESCRIPTION

### Overview

This disclosure describes embodiments such as a method for processing battery data, a method for storing battery data in a cloud server, a data processing device and a cloud server.

In one embodiment of this disclosure, a client device is an Internet of Things (IoT) device, such as electric vehicles, energy storage systems, etc. The client device provides battery data to a data processing device. The battery data are sequenced and decoded on the data processing device, then transmitted to the cloud server and stored on it.

In one embodiment of this disclosure, the battery data can be real-time collected, processed and stored between the client device and cloud server. It could support real-time monitoring of the data, which could meet the demand from customers to monitor the EV/ESS status and alert. The cloud server could conduct cloud computing services, which could meet the increasing demand for high computing power, scalability, and flexibility.

### Computing Environment

FIG. 1 is a block diagram of a computing system 10 which comprises a client device 16, a data processing device 12 and a cloud server 14. The client device 16 is an Internet of Things (IoT) device, such as electric vehicles, energy storage systems, etc. The client device comprises BMS 40 and batteries 41. BMS 40 gathers battery data from batteries 41. The data processing device 12 real-time collects the battery data from the BMS 40, processes and transmits the battery data to the cloud server 33. The battery data are stored in the cloud server 33.

The data processing device 12 can be implemented as a single device or as a group of devices. One or more of these devices can include one or more processors 20, a network interface 21, a user interface 22, a BMS interface 23, and a non-transitory computer-readable memory 24 that stores instructions executable on the one or more processors 20. These instructions can implement, among other software components, a data processing application 25 that implements a method for processing battery data, as discussed in detail below. More generally, the data processing device 12 can include any suitable type of processing hardware configured for real-time collecting and processing battery data.

The network interface 21 is configured to communicate with the cloud device 14 and other devices using any suitable protocols via the network 16, which can be a wide area network (WAN), a local area network (LAN), etc., and can include any suitable number of wired and/or wireless links.

The network interface 21 can be implemented as a cellular connection. The cellular connection is achieved by mounting a cellular module which enables high-bandwidth cellular connectivity on the data processing device 12. The cellular module includes a 3G/4G & Long-Term Evolution (LTE) base module, a PCI Express Mini Card (mini PCIe) module which is the cellular modem, an LTE Full Band PCB Antenna, and a SIM card. The base module works as a bridge between the device 12 and the cellular modem, it connects with the device 12 through Universal Serial Bus (USB) and has a port for the SIM card.

The user interface 22 can include one or more input components (e.g. a touchscreen, a microphone, a keyboard, etc.) configured to receive query requests for metrics and events and a set of alert rules to be integrated to the web-based dashboard application 25 as well as one or more output components (e.g. a screen, a speaker, etc.) configured to present a time series graph for the metrics and events and alert notifications.

The BMS interface 23 is configured to communicate with the BMS 40 for collecting the battery data. The BMS interface 23 may be implemented as a CAN module. The CAN module which is a bi-directional port-powered USB to CAN converter is connected to the data processing device 12 via USB and on the other side connects with the CAN cable from the BMS 40 in the client device 16. Therefore, the CAN data can be sent from the BMS 40 (data source) to the converter and then to the data processing device 12. Software configuration on the device 12 includes setting the baud rate of the CAN channel the same as the baud rate on the CAN bus.

Similar to the network interface 21 in the data processing device 12, the cloud device 14 can include a network interface 31 configured to communicate with the data processing device 12 and other devices using any suitable protocols via the network 16, which can be a wide area network (WAN), a local area network (LAN), etc., and can include any suitable number of wired and/or wireless links.

The cloud device 14 also can include one or more processors 30 and a non-transitory computer-readable memory 33 that stores instructions executable on the one or more processors 30. These instructions can implement, among other software components, a data storing application 34 that implements a method for storing battery data, as discussed in detail below. In this case, the cloud device 14 can serve as a storing server for battery data.

Further, similar to the user interface 22 in the data processing device 12, the cloud device 14 can include a user interface 32 including one or more input components (e.g. a touchscreen, a microphone, a keyboard, etc.).

More generally, the cloud device 14 can include any suitable type of processing hardware configured for processing and storing the battery data.

### Methods for Processing Battery Data

In one implementation illustrated in FIG. 1, the data processing application 25 is stored in the memory 24 as a set of instructions executed by the one or more processors 20. The data processing application 25 can real-time receive (collect), from BMS 40 in the client device 16, the battery data via a CAN protocol. The received battery data may also be referred to as CAN data. BMS 40 may also be referred to as a data source.

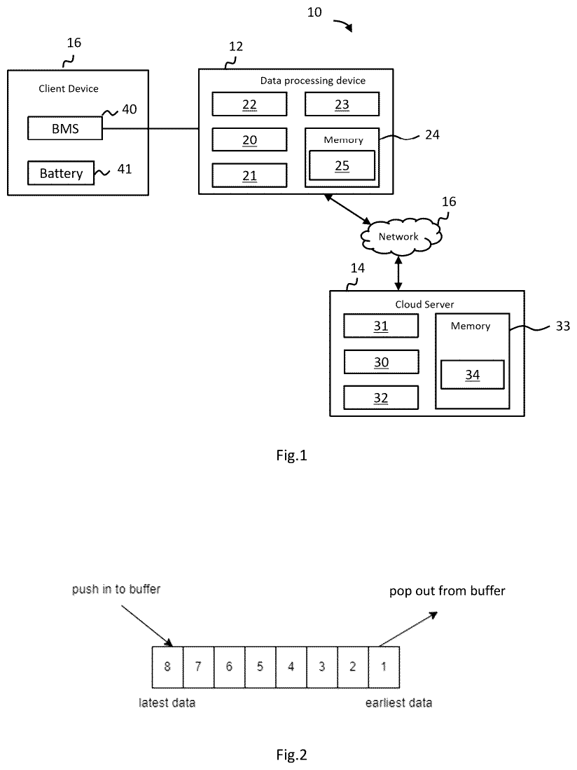

After receiving the battery data, the data processing application 25 pushes the battery data into a buffer sequentially. The time-series battery data are received from BMS 40. Specially, once the battery data is received, it will be pushed into the buffer sequentially, as show in FIG. 2.

When the buffer is filled up, the earliest battery data is popped out from the buffer.

The data processing application 25 decodes the popped battery data with a CAN DBC file provided by the client device. Specially, the popped battery data is decoded with a CAN DBC file (CAN database) provided by the BMS 40.

The received battery data are sequentially decoded. The decoded battery data is associated with a topic based on content of the battery data.

The data processing application 25 packs the decoded battery data into a JSON (JavaScript Object Notation) file, and transmits the JSON file to the cloud server 14.

Specially, the JSON file is transmitted to the cloud server 14 via MQTT (Message Queuing Telemetry Transport) protocol through a data distribution server. More specifically, the data processing device 12 is set up as an MQTT client to send data (JSON file) to an MQTT broker. The software configuration for MQTT client includes setting a port for the secured MQTT connection and configuring the credentials for the communication with MQTT broker. The data will be transmitted from the device 12 to the MQTT broker sequentially, and then transmitted from the MQTT broker to the cloud server 14. A certain rule is defined for the transmission so that the data can be stored in the desired location in the cloud server 14.

The data distribution server (not shown) may be Apache Kafka cluster or a managed cloud platform such as AWS (Amazon Web Services) IoT core.

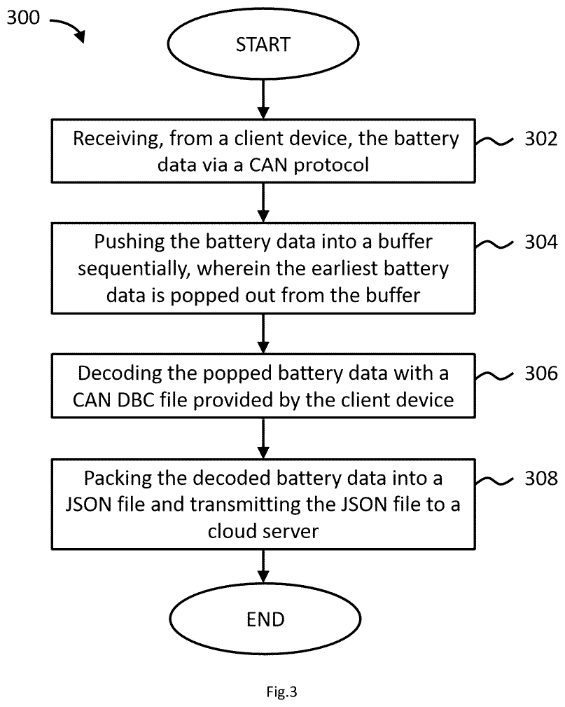

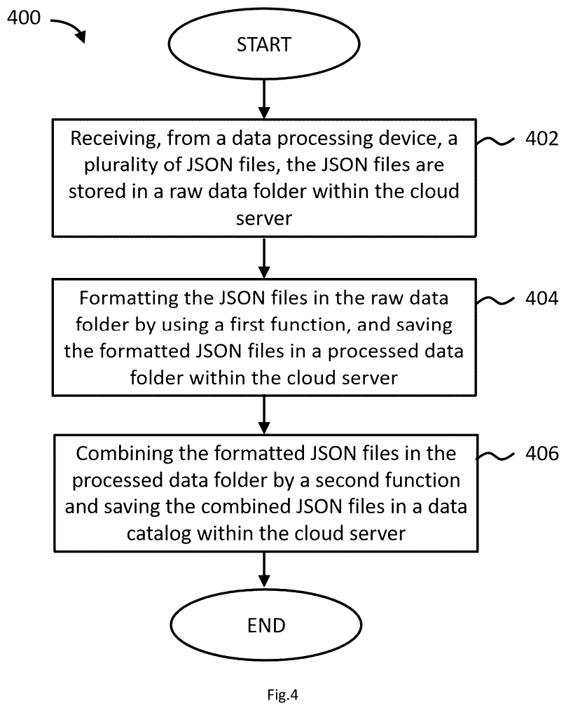

The method of FIG. 3 can be implemented in a data processing device, for example. However, this or similar method also can be implemented in other suitable devices.

The method 300 begins at block 302, where a plurality of battery data is received. In particular, the battery data is received real-time from BMS 40 in the client device 16 via a CAN protocol.

At block 304, the battery data is pushed into a buffer sequentially, wherein the earliest battery data is popped out from the buffer. In particular, the time-series battery data are received from BMS 40. Specially, once the battery data is received, it will be pushed into the buffer sequentially, as show in FIG. 2. When the buffer is filled up, the earliest battery data is popped out from the buffer.

Next, at block 306, the popped battery data is decoded with a CAN DBC file provided by the client device 16. Specially, the popped battery data is decoded with a CAN DBC file (CAN database) provided by the BMS 40.

The received battery data are sequentially decoded. The decoded battery data is associated with a topic based on content of the battery data

The decoded battery data is packed into a JSON (JavaScript Object Notation) file, and the JSON file is transmitted to the cloud server 14 at block 308.

Specially, the JSON file is transmitted to the cloud server 14 via MQTT (Message Queuing Telemetry Transport) protocol through a data distribution server. More specially, the data processing device 12 is set up as an MQTT client to send data (JSON file) to an MQTT broker. The software configuration for MQTT client includes setting a port for the secured MQTT connection and configuring the credentials for the communication with MQTT broker. The data will be transmitted from the device 12 to the MQTT broker sequentially, and then transmitted from the MQTT broker to the cloud server 14. A certain rule is defined for the transmission so that the data can be stored in the desired location in the cloud server 14.

The data distribution server (not shown) may be Apache Kafka cluster or a managed cloud platform such as AWS (Amazon Web Services) IoT core.

### Methods for Storing Battery Data in a Cloud Server

In the example implementation illustrated in FIG. 1, the data storing application 34 is stored in the memory 33 as a set of instructions executed by the one or more processors 30. The data storing application 34 receives a plurality of JSON files from the data processing device 12.

Specially, there are a data lake and a data catalog within the cloud server 14. The data catalog is separate from the data lake. There are two folders, a raw data folder and a processed data folder, in the data lake.

The received JSON files are stored in the raw data folder. Specially, the JSON files sent from MQTT broker are first stored in the raw data folder.

The data storing application 34 then formats the JSON files in the raw data folder by using a first function, and saves the formatted JSON files in the processed data folder.

The first function is a filtering function. For example, the filtering function is a lambda function. The lambda function formats the JSON files in the correct data type in the raw data folder.

More specially, the lambda function filters the JSON files in the raw data folder so as to remove invalid data or null data. The formatted (filtered) JSON files do not include invalid data or null data. The formatted JSON files are saved in the processed data folder.

After formatting, the data storing application 34 combines the formatted JSON files in the processed data folder by a second function and saves the combined JSON files in the data catalog.

Specially, the second function is a combining function. For example, the combining function is another lambda function. Another lambda function classifies the formatted JSON files and combines the formatted JSON files with the same type into the combined JSON files.

More specially, another lambda function triggers a crawler to combine the formatted JSON files in the processed data folder together. The combined JSON files are saved in the tables of the Data Catalog. That is, the battery data are saved in the tables of the Data Catalog, as show in FIG. 5.

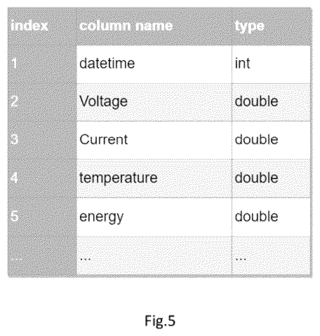

The method shown in FIG. 4 can be implemented in a cloud server 14, for example. However, this or similar method also can be implemented in other suitable servers.

The method 400 begins at block 402, where a plurality of JSON files are received from the data processing device 12.

Specially, there are a data lake and a data catalog within the cloud server 14. The data catalog is separated from the data lake. There are two folders, a raw data folder and a processed data folder, in the data lake.

The received JSON files are stored in the raw data folder. Specially, the JSON files sent from MQTT broker are first stored in the raw data folder.

At block 404, the JSON files in the raw data folder are formatted by using a first function, and the formatted JSON files are saved in the processed data folder.

The first function is a filtering function. For example, the filtering function is a lambda function. The lambda function formats all the JSON files in the correct data type in the raw data folder.

More specially, the lambda function filters all the JSON files in the raw data folder so as to remove invalid data or null data. The formatted (filtered) JSON files do not include any invalid data or null data. The formatted JSON files are saved in the processed data folder.

At block 406, the formatted JSON files in the processed data folder are combined by a second function, and the combined JSON files are saved in the data catalog.

Specially, the second function is a combining function. For example, the combining function is another lambda function. Another lambda function classifies the formatted JSON files and combines the formatted JSON files with the same type into the combined JSON files.

More specially, another lambda function triggers a crawler to combine the formatted JSON files in the processed data folder together. The combined JSON files are saved in the tables of the Data Catalog. That is, the battery data are saved in the tables of the Data Catalog, as show in FIG. 5.

### Additional Considerations

The various operations of the methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a cloud computing environment or as a software as a service (SaaS). For example, at least some of the operations may be performed by a group of computers (as examples of machines including processors), these operations being accessible via a network (e.g., the Internet) and via one or more appropriate interfaces (e.g., application program interfaces (APIs).)

Upon reading this disclosure, those of ordinary skill in the art will appreciate still additional alternative structural and functional designs for real-time monitoring and alarming for battery test. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method for processing battery data, comprising:
receiving, from a client device, the battery data via a CAN protocol;
pushing the battery data into a buffer sequentially, wherein the earliest battery data is popped out from the buffer;
decoding the popped battery data with a CAN DBC file provided by the client device;
packing the decoded battery data into a JSON file and transmitting the JSON file to a cloud server.

2. The method of claim 1, wherein the client device comprises a battery management system (BMS), the BMS gathers the battery data from batteries in the client device.

3. The method of claim 1, wherein transmitting the JSON file to a cloud server comprises transmitting the JSON file to the cloud server via MQTT protocol through data distribution server.

4. The method of claim 1, wherein the CAN DBC file is provided by the BMS.

5. The method of claim 1, wherein the decoded battery data is associated with a topic based on content of the battery data.

6. A data processing device, comprising:
one or more processors; and
a non-transitory computer-readable memory coupled to the one or more processors, the memory storing instructions that, when executed by the one or more processors, cause the one or more processors to perform operations comprising:
receiving, from a client device, the battery data via a CAN protocol;
pushing the battery data into a buffer sequentially, wherein the earliest battery data is popped out from the buffer;
decoding the popped battery data with a CAN DBC file provided by the client device;
packing the decoded battery data into a JSON file and transmitting the JSON file to a cloud.

7. The data processing device of claim 6, wherein the client device comprises a battery management system (BMS), the BMS gathers the battery data from batteries in the client device.

8. The data processing device of claim 6, wherein transmitting the JSON file to a cloud server comprises transmitting the JSON file to the cloud server via MQTT protocol through data distribution server.

9. The data processing device of claim 6, wherein the CAN DBC file is provided by the BMS.

10. The data processing device of claim 6, wherein the decoded battery data is associated with a topic based on content of the battery data.

11. A method for storing battery data in a cloud server, comprising:
receiving, from a data processing device, a plurality of JSON files, wherein the JSON files are stored in a raw data folder within the cloud server;
formatting the JSON files in the raw data folder by using a first function, and saving the formatted JSON files in a processed data folder within the cloud server; and
combining the formatted JSON files in the processed data folder by a second function and saving the combined JSON files in a data catalog within the cloud server.

12. The method of claim 11, wherein the first function is a filtering function,
wherein, the formatting the JSON files in the raw data folder by using a first function comprises filtering the JSON files in the raw data folder by using the filtering function so as to remove invalid data or null data.

13. The method of claim 11, wherein the second function is a combining function,
wherein, the combining the formatted JSON files in the processed data folder by a second function comprises classifying the formatted JSON files and combining the formatted JSON files with the same type into the combined JSON files.

14. The method of claim 11, wherein the raw data folder and the processed data folder are in a data lake within the cloud server, the data catalog is separated from the data lake.

15. A cloud server, comprising:
one or more processors; and
a non-transitory computer-readable memory coupled to the one or more processors, the memory storing instructions that, when executed by the one or more processors, cause the one or more processors to perform operations comprising:
receiving, from a data processing device, a plurality of JSON files, wherein the JSON files are stored in a raw data folder within the cloud server;
formatting the JSON files in the raw data folder by using a first function, and saving the formatted JSON files in a processed data folder within the cloud server;
combining the formatted JSON files in the processed data folder by a second function and saving the combined JSON files in a data catalog within the cloud server.

16. The cloud server of claim 15, wherein the first function is a filtering function,
wherein, the formatting the JSON files in the raw data folder by using a first function comprises filtering the JSON files in the raw data folder by using the filtering function so as to remove invalid data or null data.

17. The cloud server of claim 15, wherein the second function is a combining function,
wherein, the combining the formatted JSON files in the processed data folder by a second function comprises classifying the formatted JSON files and combining the formatted JSON files with the same type into the combined JSON files.

18. The cloud server of claim 15, wherein the raw data folder and the processed data folder are in a data lake within the cloud server, the data catalog is separated from the data lake.
